(19) United States
(12) Patent Application Publication
(10) Pub. No.: US 2016/0195159 A1
(43) Pub. Date: Jul. 7, 2016

(54) CENTRIFUGAL-PENDULUM VIBRATION ABSORBING DEVICE

(71) Applicant: AISIN AW CO., LTD., Anjo-shi, Aichi-ken (JP)

(72) Inventors: Yoshihiro TAKIKAWA, Tsuchima (JP); Yoichi OI, Ama (JP); Takayuki MIYAOKA, Anjo (JP); Yuichiro HIRAI, Okazaki (JP)

(73) Assignee: AISIN AW CO., LTD., Anjo-shi, Aichi-ken (JP)

(21) Appl. No.: 14/902,762

(22) PCT Filed: Aug. 6, 2014
(86) PCT No.: PCT/JP2014/070771

§ 371 Date: Jan. 4, 2016

(30) Foreign Application Priority Data
Aug. 9, 2013 (JP) 2013-166094

(51) Int. Cl. F16F 15/14

(52) U.S. Cl. CPC F16F 15/145

(57) ABSTRACT

A mass body that includes two weights that face each other via a support member is provided. Each of the two weights is formed with a recessed portion that is recessed from an outside surface toward an inside surface. An additional weight formed of a material that is higher in specific gravity than the weight is attached to the recessed portion. Consequently, the weight of the mass body can be increased without increasing the radial length or the thickness of the mass body (weights). As a result, the vibration damping effect can be improved while suppressing an increase in size of the device.

### CROSS REFERENCE TO RELATED APPLICATIONS

This application is a National Stage of International Application No. PCT/JP2014/070771 filed Aug. 6, 2014, claiming priority based on Japanese Patent Application No. 2013-166094 filed Aug. 9, 2013, the contents of all of which are incorporated herein by reference in their entirety.

### TECHNICAL FIELD

The present subject matter relates to a centrifugal-pendulum vibration absorbing device.

### BACKGROUND ART

There has hitherto been proposed a centrifugal-pendulum vibration absorbing device that includes an annular support member coaxially attached to a rotary element and a plurality of mass bodies each swingably supported by the support member and disposed adjacent to each other in the circumferential direction (see Patent Document 1, for example). In the centrifugal-pendulum vibration absorbing device, each of the mass bodies is constituted by coupling two arcuate weights, which face each other via the support member, using a coupling member such as a rivet.

### RELATED-ART DOCUMENTS

### Patent Documents

[Patent Document 1] German Patent Application Publication No. 10 2010 049 558 A1

### SUMMARY

In the centrifugal-pendulum vibration absorbing device, in general, the vibration damping effect can be improved by increasing the weight of each of the mass bodies. However, increasing the radial length and the thickness of the two weights in order to increase the mass of the mass bodies may incur an increase in size of the device, that is, an increase in outside diameter and axial length of the device.

It is a main object of the centrifugal-pendulum vibration absorbing device according to the present disclosure to improve the vibration damping effect while suppressing an increase in size of the device.

In order to achieve the foregoing main object, the centrifugal-pendulum vibration absorbing device according to the present disclosure adopts the following configuration.

The present disclosure provides
a centrifugal-pendulum vibration absorbing device including:
a support member attached to a rotary element; and
a plurality of mass bodies each swingably supported by the support member and disposed adjacent to each other in a circumferential direction, in which:
the mass bodies each include two weights coupled to face each other via the support member;
each of the weights are provided with a recessed portion that is recessed from a surface of each of the weights toward an inner side of each of the weights; and
an additional weight formed of a material that is higher in specific gravity than each of the weights is attached to the recessed portion.

In the centrifugal-pendulum vibration absorbing device according to the present disclosure, the plurality of mass bodies are swingably supported by the support member which is attached to the rotary element, and disposed adjacent to each other in the circumferential direction (on a circle centered on the axis of the rotary element and the support member); each of the two weights of the mass bodies is provided with a recessed portion that is recessed from a surface of each of the weights toward the inner side of each of the weights; and the additional weight which is formed of a material that is higher in specific gravity than each of the weights is attached to the recessed portion. Consequently, the weight of each of the mass bodies can be increased without increasing the radial length (the length in a direction that is orthogonal to a direction (the axial direction of each of the mass bodies) that is parallel to the axial direction of the rotary element and the support member and away from the axis of the rotary element and the support member) or the thickness of each of the mass bodies. As a result, the vibration damping effect can be improved while suppressing an increase in size of the device.

In the thus configured centrifugal-pendulum vibration absorbing device according to the present disclosure, the recessed portion may be formed at both end portions, in the circumferential direction, of each of the weights. This allows an increase in rotation moment of each of the mass bodies about the center of gravity.

In the centrifugal-pendulum vibration absorbing device according to the present disclosure, in addition, the recessed portion may be a recessed portion that is recessed from one of an outside surface and an inside surface, in an axial direction (a direction that is parallel to the axial direction of the rotary element and the support member), of each of the weights toward the other; a through hole may be formed in a bottom surface of the recessed portion of each of the weights and the additional weight; and the two weights may be coupled to each other by a rivet inserted through the through hole in the recessed portion of each of the weights and the additional weight. This facilitates coupling of the two weights to each other and attachment of the additional weight to the recessed portion of each of the weights. In the centrifugal-pendulum vibration absorbing device according to such an aspect of the present disclosure, the additional weight may be provided with a rivet recessed portion that accommodates both end portions of the rivet. This allows a further reduction in length, in the axial direction, of each of the mass bodies.

In the centrifugal-pendulum vibration absorbing device according to the present disclosure, further, the recessed portion may be a recessed portion that is recessed from an outside surface toward an inside surface of each of the weights in an axial direction. This facilitates attachment of the additional weight to the recessed portion of each of the weights compared to a configuration in which the recessed portion is a recessed portion that is recessed from the inside surface toward the outside surface of each of the weights in the axial direction.

In the centrifugal-pendulum vibration absorbing device according to the present disclosure, additionally, each of the weights may be provided with a projecting portion that forms a bottom surface of the recessed portion and that projects in a coupling direction of each of the two weights; and a cushioning member may be attached to an attachment portion constituted from the projecting portion of each of the two weights.

This makes it possible to reduce a shock applied when the cushioning member and the support member collide against each other or when the respective cushioning members of the mass bodies which are adjacent to each other in the circumferential direction collide against each other along with swing of the mass bodies, and to improve the durability of the device. This also facilitates manufacture of each of the weights by pressing of a plate body in the case where the recessed portion is a recessed portion that is recessed from the outside surface toward the inside surface of each of the weights in the axial direction. That is, each of the weights is shaped to include the projecting portion which projects on the side of the inside surface (in the coupling direction of the two weights). Therefore, in the case where pressing is performed to form each of the weights, a material moved to form the recessed portion can be displaced toward the projecting portion, which can facilitate manufacture of each of the weights by pressing.

In the centrifugal-pendulum vibration absorbing device according to the aspect of the present disclosure in which each of the weights is provided with the projecting portion, the recessed portion and the projecting portion may be formed by pressing a plate body. This facilitates formation of the recessed portion and the projecting portion.

In the centrifugal-pendulum vibration absorbing device according to the aspect of the present disclosure in which each of the weights is provided with the projecting portion, in addition, a through hole may be formed in the projecting portion and the additional weight; and the two weights may be coupled to each other by a rivet inserted through the through hole in the projecting portion and the additional weight. This facilitates coupling of the two weights to each other and attachment of the additional weight to the recessed portion of each of the weights. In the centrifugal-pendulum vibration absorbing device according to such an aspect of the present disclosure, the additional weight may be provided with a rivet recessed portion that accommodates both end portions of the rivet. This allows a further reduction in length, in the axial direction, of each of the mass bodies.

In the centrifugal-pendulum vibration absorbing device according to the present disclosure, the two weights may be coupled to each other by a rivet formed of a material that is higher in specific gravity than each of the weights; and both end portions of the rivet may be disposed in the recessed portion to function as the additional weight. This allows the rivet, which couples the two weights to each other, to function also as the additional weight.

In the centrifugal-pendulum vibration absorbing device according to the present disclosure, in addition, each of the mass bodies may be supported by the support member so as to be swingable about a pendulum fulcrum and rotatable about a center of gravity. This makes it possible to damp vibration to be transmitted to the support member utilizing not only rotation about the pendulum fulcrum but also a rotation moment of each of the mass bodies about the center of gravity. As a result, the vibration damping effect of the centrifugal-pendulum vibration absorbing device can be further improved.

### BRIEF DESCRIPTION OF THE DRAWINGS

FIG. 1 is a diagram illustrating a schematic configuration of a starting device 1 that includes a centrifugal-pendulum vibration absorbing device 10 according to an embodiment of the present disclosure.

FIG. 2 is a front view of the centrifugal-pendulum vibration absorbing device 10.

FIG. 3 is an A-A sectional view illustrating an A-A section of the centrifugal-pendulum vibration absorbing device 10 of FIG. 2.

FIG. 4 is a B-B sectional view illustrating a B-B section of the centrifugal-pendulum vibration absorbing device 10 of FIG. 2.

FIG. 5 is a C-C sectional view illustrating a C-C section of the centrifugal-pendulum vibration absorbing device 10 of FIG. 2.

FIG. 6 illustrates a schematic configuration of a mass body 12B of a centrifugal-pendulum vibration absorbing device 10B according to a modification.

FIG. 7 illustrates a schematic configuration of a mass body 12C of a centrifugal-pendulum vibration absorbing device 10C according to a modification.

FIG. 8 illustrates a schematic configuration of a mass body 12D of a centrifugal-pendulum vibration absorbing device 10D according to a modification.

FIG. 9 illustrates a schematic configuration of a mass body 12E of a centrifugal-pendulum vibration absorbing device 10E according to a modification.

Now, a mode for carrying out the present disclosure will be described by way of an embodiment.

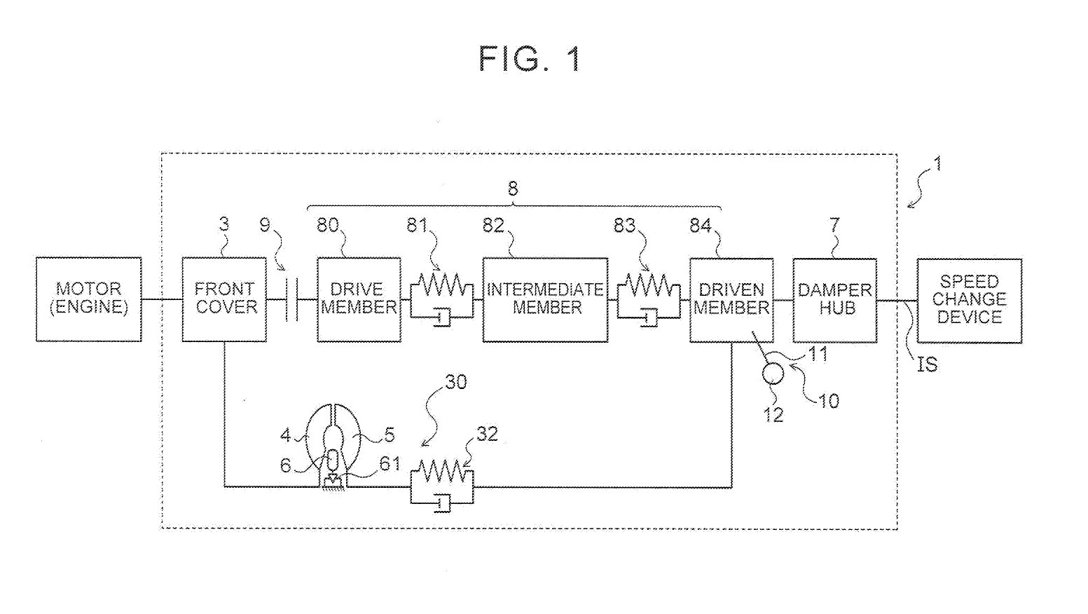

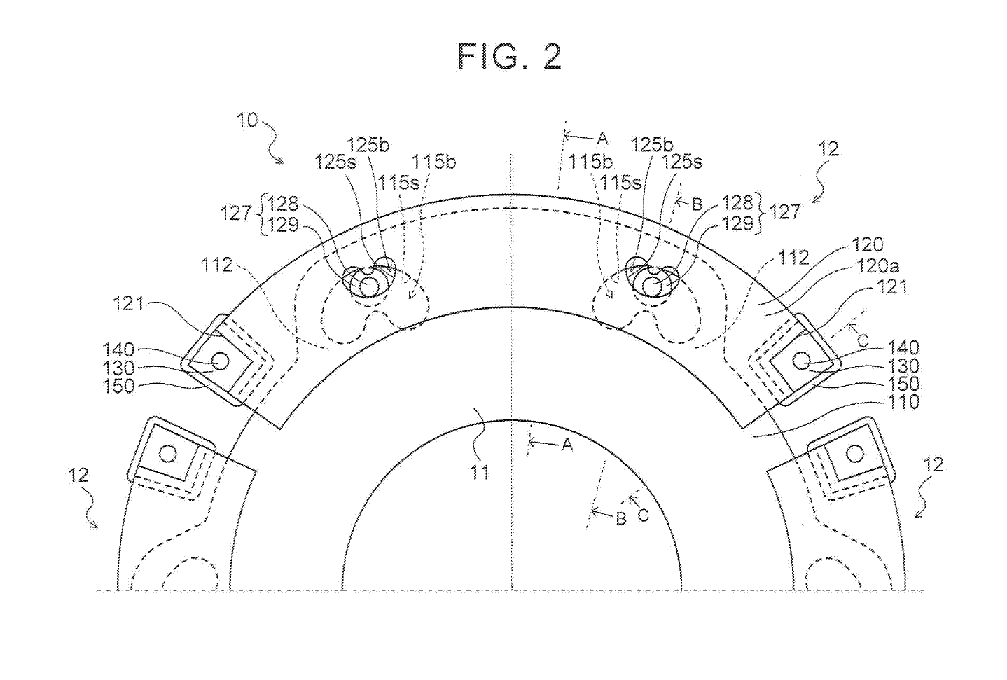

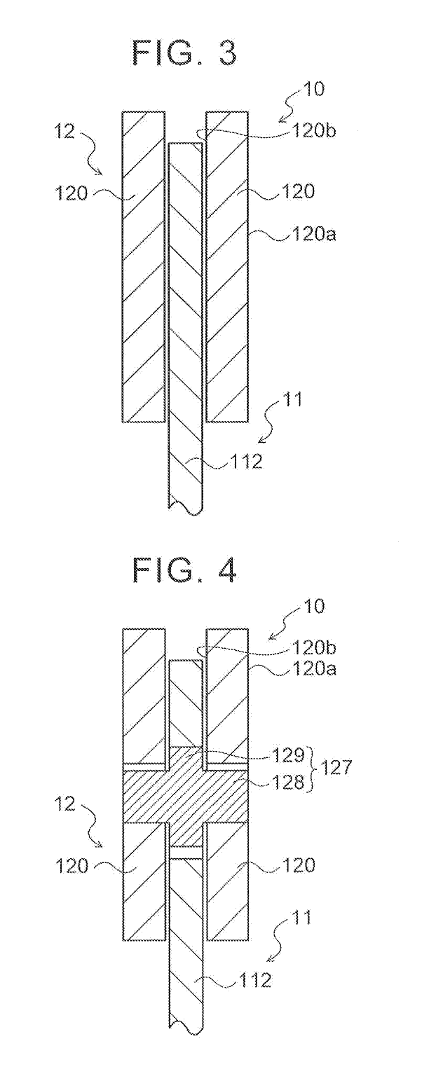

FIG. 1 is a diagram illustrating a schematic configuration of a starting device 1 that includes a centrifugal-pendulum vibration absorbing device 10 according to an embodiment of the present disclosure. FIG. 2 is a front view of the centrifugal-pendulum vibration absorbing device 10. FIGS. 3 to 5 are an A-A sectional view, a B-B sectional view, and a C-C sectional view illustrating an A-A section, a B-B section, and a C-C section, respectively, of the centrifugal-pendulum vibration absorbing device 10 of FIG. 2.

As illustrated in the drawings, a starting device 1 according to the embodiment is mounted on a vehicle, and constituted as a device that transmits power from an engine (internal combustion engine) that serves as a motor to an automatic transmission (AT) or a continuously variable transmission (CVT) that serves as a speed change device. The starting device 1 includes: a front cover (an input member) 3 coupled to a crankshaft of the engine; a pump impeller (an input-side fluid transmission element) 4 fixed to the front cover 3; a turbine runner (an output-side fluid transmission element) 5 disposed coaxially with the pump impeller 4 so as to be rotatable; a stator 6 that rectifies a flow of working oil (a working fluid) from the turbine runner 5 to the pump impeller 4; a damper hub (an output member) 7 fixed to an input shaft IS of the speed change device; a damper mechanism 8 connected to the damper hub 7; a single-plate friction or multi-plate friction lock-up clutch mechanism 9 interposed between the front cover 3 and the damper mechanism 8; and a centrifugal-pendulum vibration absorbing device 10 and a dynamic damper 30 coupled to the damper mechanism 8.

The pump impeller 4 and the turbine runner 5 face each other. The stator 6 is disposed between and coaxially with the pump impeller 4 and the turbine runner 5 so as to be rotatable. The rotational direction of the stator 6 is set to one direction by a one-way clutch 61. The pump impeller 4, the turbine runner 5, and the stator 6 form a torus (an annular flow passage) that allows circulation of working oil, and function as a torque converter with a torque amplification function. In the starting device 1, the stator 6 and the one-way clutch 61 may be omitted, and the pump impeller 4 and the turbine runner 5 may function as a fluid coupling.

The damper mechanism 8 includes: a drive member (an input element) 80 that is rotatable together with a lock-up piston of the lock-up clutch mechanism 9; a plurality of first coil springs (first elastic bodies) 81; an intermediate member (an intermediate element) 82 engaged with the drive member 80 via the plurality of first coil springs 81; a plurality of second coil springs (second elastic bodies) 83; and a driven member (an output element) 84 engaged with the intermediate member 82 via the plurality of second coil springs 83 and fixed to the damper hub 7.

The lock-up clutch mechanism 9 is a mechanism that operates using a hydraulic pressure from a hydraulic control device (not illustrated). The lock-up clutch mechanism 9 establishes and releases lock-up in which the front cover (an input member) 3 and the damper hub 7, that is, the input shaft IS of the speed change device, are coupled to each other via the damper mechanism 8. When lock-up is established by the lock-up clutch mechanism 9, power from the engine which serves as a motor is transferred to the input shaft IS of the speed change device via the front cover 3, the lock-up clutch mechanism 9, the drive member 80, the first coil springs 81, the intermediate member 82, the second coil springs 83, the driven member 84, and the damper hub 7. In this event, fluctuations in torque input to the front cover 3 are mainly absorbed by the first coil springs 81 and the second coil springs 83 of the damper mechanism 8.

The dynamic damper 30 is coupled to the driven member 84 of the damper mechanism 8, and includes the turbine runner 5 which serves as a mass body and a plurality of third springs (third elastic bodies) 32 interposed between the driven member 84 and the turbine runner 5. The “dynamic damper” is a mechanism that absorbs (damps) vibration of a vibrating body by applying vibration in the opposite phase at a frequency (engine rotational speed) that coincides with the resonance frequency of the vibrating body to the vibrating body, and is constituted by coupling the springs and the mass body to each other such that the spring and the mass body are not included in the torque transfer path. The dynamic damper 30 can be caused to act at a desired frequency by adjusting the rigidity of the third springs and the weight of the mass body. With the dynamic damper 30 coupled to the driven member 84 of the damper mechanism 8, vibration of the driven member 84, and hence the entire damper mechanism 8, can be absorbed (damped) well by both the centrifugal-pendulum vibration absorbing device 10 and the dynamic damper 30 during lock-up.

As illustrated in FIG. 2, the centrifugal-pendulum vibration absorbing device 10 includes: a support member (a flange) 11 coaxially attached to the driven member 84 (see FIG. 1), which serves as a rotary element, of the damper mechanism 8; and a plurality of (in the embodiment, three) mass bodies 12 each swingably supported by the support member 11 and disposed adjacent to each other in the circumferential direction (on a circle centered on the axis of the driven member 84 and the support member 11). In the centrifugal-pendulum vibration absorbing device 10, along with rotation of the support member 11, the plurality of mass bodies 12 are swung with respect to the support member 11 to apply vibration in the phase opposite to that of vibration (resonance) of the driven member 84 of the damper mechanism 8 to the driven member 84 to absorb vibration.

The support member 11 is constituted as an annular plate formed by pressing or the like of a metal plate formed of iron or the like, for example, and coupled to the driven member 84 of the damper mechanism 8 via a rivet (not illustrated). Thus, the support member 11 is rotated coaxially and together with the driven member 84. It should be noted, however, that the support member 11 may be coupled to the drive member 80 or the intermediate member 82 of the damper mechanism 8.

In addition, the support member 11 includes a small-diameter portion 110, and a plurality of (in the embodiment, three) large-diameter portions 112 that project radially outward from the small-diameter portion 110 and that swingably support the respective mass bodies 12. Each of the large-diameter portions 112 is provided with two guide opening portions (support member-side guide notch portions) 115a and 115b for guiding two guide rollers 127 together with two guide opening portions 125a and 125b of the corresponding mass body 12 such that the mass body 12 is moved along a track determined in advance. The guide opening portion 115a and the guide opening portion 115b are formed as long holes that are asymmetrical and that each extend with a curve that is convex toward the radially outer side of the support member 11 as their axis, and formed to be shaped as a mirror image of each other. It should be noted, however, that the guide opening portion 115a and the guide opening portion 115b may also be formed as long holes that are symmetrical. One guide opening portion 115a and one guide opening portion 115b are provided for each of the mass bodies 12, spaced from each other, and disposed in the circumferential direction symmetrically about the swing center line of the mass body 12 (a line that connects between the pendulum fulcrum (the axial center of the starting device 1 and the centrifugal-pendulum vibration absorbing device 10) and the point of application (see the dotted line in FIG. 2)).

As illustrated in FIGS. 2 to 5, each of the mass bodies 12 includes: two weights 120 coupled to face each other in the axial direction of the support member 11 (the direction of penetrating the sheet surface of FIG. 2); two guide opening portions (mass body-side guide notch portions) 125a and 125b formed in each of the weights 120; two guide rollers 127 that are guided by the guide opening portions 125a and 125b and the guide opening portions 115a and 115b of the support member 11 to roll; and additional weights 130 for increasing the weight of the mass body 12.

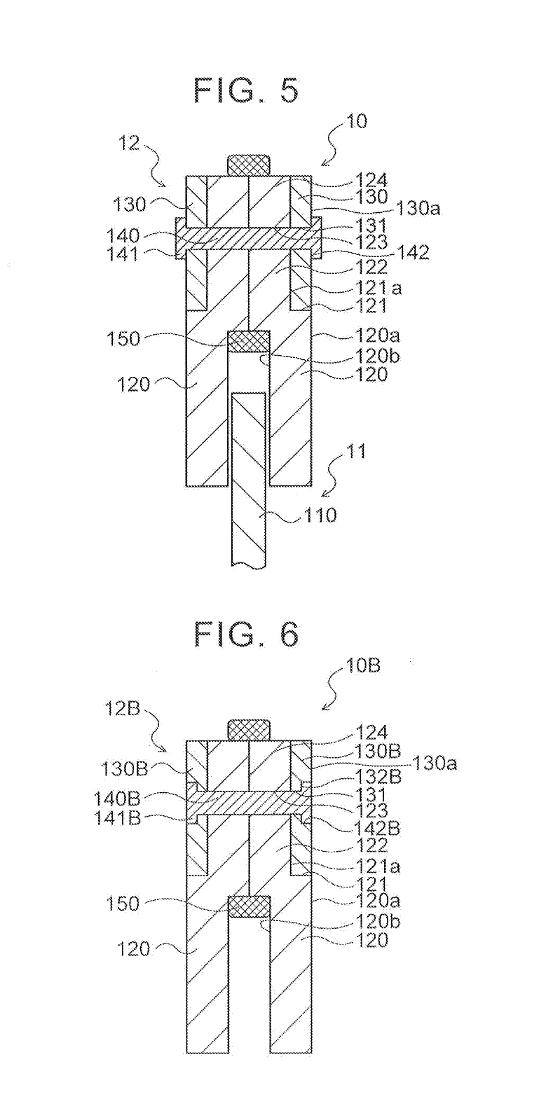

The weights 120 are formed of iron or the like, for example. As illustrated in FIG. 2, each of the weights 120 is curved in a generally arcuate shape so as to extend along the outer periphery of the large-diameter portion of the support member 11 and formed in a symmetrical shape about the swing center line (see the dotted line in FIG. 2) of the mass body 12 as seen in the axial direction of the support member 11. As illustrated in FIGS. 2 and 5, a recessed portion 121 and a projecting portion 122 are formed at the outer peripheral portion of both end portions, in the circumferential direction, of each of the weights 120 (a portion on the outer peripheral side with respect to generally the center of each of the weights 120 in the radial direction (a direction that is orthogonal to the axial direction of the driven member 84 and the support member 11 and away from the axial center of the driven member 84 and the support member 11)). The recessed portion 121 is recessed from an outside surface 120a in the axial direction of the weight 120 (a direction that is parallel to the axial direction of the driven member 84 and the support member 11) toward an inside surface 120b in the axial direction. The projecting portion 122 forms a bottom surface 121a of the recessed portion 121, and projects in a coupling direction of the weights 120 (toward the opposing weight 120). In the embodiment, the recessed portion 121 and the projecting portion 122 are formed by pressing a flat metal plate (plate body). In addition, a through hole 123 is formed in the projecting portion 122 of each of the weights 120.

The additional weight 130 which is formed of a material (such as nickel, copper, or molybdenum, for example) that is greater in specific gravity than the weight 120 is disposed in the recessed portion 121 of each of the weights 120. The additional weight 130 is formed so as to match the recessed portion 121 (such that the volume (area and thickness) of the additional weight 130 is generally equal to the volume (area and depth) of the recessed portion 121). In addition, as illustrated in FIG. 5, a through hole 131 is formed in the additional weight 130 at a position (on the extension of the through hole 123) at which the through hole 131 matches the through hole 123 of the projecting portion 122 when the additional weight 130 is disposed in the recessed portion 121 of the weight 120.

Each of the mass bodies 12 is constituted by inserting a rivet 140 through the through holes 131, 123, 123, and 131 in a state in which the two weights 120 face each other and the projecting portions 122 abut against each other and in which the additional weight 130 is disposed in the recessed portion 121 of each of the two weights 120, that is, the through hole 131 of the additional weight 130, the through hole 123 of the projecting portion 122, the through hole 123 of the projecting portion 122, and the through hole 131 of the additional weight 130 are arranged in this order to match each other, and swaging a distal end portion 142 of the rivet 140 to couple the additional weight 130, the projecting portion 122, the projecting portion 122, and the additional weight 130 to each other. It should be noted, however, that a head portion 141 and the distal end portion (swaging portion) 142 of the rivet 140 project in the left-right direction of FIG. 5 from respective outside surfaces 130a of the additional weights 130.

In this way, by attaching the additional weight 130 to each of the recessed portions 121 formed on the side of the outside surfaces 120a of the two weights 120, the weight of the mass body 12 can be increased without increasing the radial length or the thickness of the mass body 12 (weights 120) compared to a configuration in which the radial length or the thickness of the mass body 12 (weights 120) is increased and a configuration in which the additional weight 130 is attached adjacent to each of the outside surfaces 120a without forming the recessed portions 121 in the weights 120. In addition, with the recessed portions 121 formed on the side of the outside surfaces 120a of the two weights 120, the additional weight 130 can be easily attached to the recessed portion 121 of each of the weights 120 compared to a configuration in which recessed portions are formed on the side of the inside surfaces 120b. Further, forming the recessed portions 121 and the projecting portions 122 of the weight 120 by pressing can facilitate processing. Specifically, the weight 120 is shaped to include the projecting portion 122 which projects on the side of the inside surface 120b (in the coupling direction of the two weights). Therefore, in the case where pressing is performed to form the weight 120, a material moved to form the recessed portion 121 can be displaced toward the projecting portion 122, which can facilitate manufacture of the weight 120 by pressing. Additionally, coupling the two weights 120 and the additional weights 130 disposed in the respective recessed portions 121 of the two weights 120 to each other using the rivet 140 to constitute the mass body 12 can facilitate coupling of the two weights 120 to each other and attachment of the additional weights 130 to the recessed portions 121 of the weights 120.

In each of the mass bodies 12, as illustrated in FIGS. 2 and 5, a cushioning member 150 formed of an elastic body such as a rubber material is attached to an attachment portion 124 formed by bringing the respective projecting portions 122 of the two weights 120 into abutment with each other. The cushioning member 150 is constituted as a frame body, the inner periphery of which matches the outer periphery of the attachment portion 124. Thus, the volume of the attachment portion 124 can be further increased to further increase the weight of the mass body 12.

The guide opening portion 125a and the guide opening portion 125b of the mass body 12 are formed as long holes that are asymmetrical and that each extend with a curve that is convex toward the center (pendulum fulcrum) of the support member 11 as their axis, and formed to be shaped as a mirror image of each other. It should be noted, however, that the guide opening portions 125a and 125b may be formed as long holes that are symmetrical. One guide opening portion 125a and one guide opening portion 125b are provided for each of the mass bodies 12, spaced from each other, and disposed in the circumferential direction symmetrically about the swing center line of the mass body 12 (see the dotted line in FIG. 2).

As illustrated in FIGS. 2 and 4, the guide roller 127 is constituted by integrating a small-diameter roller 128 and a large-diameter roller 129 with each other. The small-diameter roller 128 projects on both sides, in the axial direction, of the large-diameter roller 129, and is rollably inserted into the guide opening portion 125a or 125b of the two weights 120 to be rollably supported by the mass body 12, that is, the two weights 120. The small-diameter roller 128 basically rolls along an inner peripheral surface 125s on the radially inner side of the corresponding guide opening portion 125a or 125b. In addition, the large-diameter roller 129 is rollably disposed in the guide opening portion 115a or 115b corresponding to the guide opening portion 125a or 125b of each of the mass bodies 12. Consequently, the mass body 12 is swingably supported by the support member 11. The large-diameter roller 129 basically rolls along an inner peripheral surface 115s on the radially outer side of the corresponding guide opening portion 115a or 115b. With such a configuration, when the support member 11 is rotated, each of the mass bodies 12 is swung with respect to the support member 11 while being guided by the guide opening portions 125a and 125b and the guide opening portions 115a and 115b via the guide rollers 127.

Now, operation of the centrifugal-pendulum vibration absorbing device 10 according to the embodiment configured as described above will be described. In the centrifugal-pendulum vibration absorbing device 10 according to the embodiment, when the support member 11 is rotated, the plurality of mass bodies 12 are swung in the same direction with respect to the support member 11 while being guided by the guide opening portions 125a and 125b and the guide opening portions 115a and 115b via the guide rollers 127 along with the rotation. Consequently, vibration that is opposite in phase to vibration of the driven member 84 can be applied to the driven member 84 to absorb (damp) vibration.

In the embodiment, as discussed above, the guide opening portion 125a and the guide opening portion 125b of each of the mass bodies 12 are formed as long holes that are asymmetrical (or symmetrical) and that each extend with a curve that is convex toward the center of the support member 11 as an axis, and disposed symmetrically to each other with respect to the swing center line of the mass body 12. In addition, the guide opening portion 115a and the guide opening portion 115b of the support member 11 corresponding to each of the mass bodies 12 are formed as long holes that are asymmetrical (or symmetrical) and that each extend with a curve that is convex toward the radially outer side of the support member 11 as an axis, and disposed symmetrically with each other about the swing center line of the mass body 12. Thus, in the centrifugal-pendulum vibration absorbing device 10 according to the embodiment, each of the mass bodies 12 can be turned about the pendulum fulcrum along with rotation of the support member 11, and rotated about the center of gravity of the mass body 12 as the mass body 12 is shaken to one side within the swing range. In this way, with the mass bodies 12 supported by the support member 11 so as to be turnable about the pendulum fulcrum and rotatable about the center of gravity, it is possible to damp vibration utilizing not only swing motion of the mass bodies 12 about the pendulum fulcrum but also a rotation moment of the mass bodies 12 about the center of gravity.

In the embodiment, in addition, the additional weight 130 is attached to each of the recessed portions 121 which are formed on the side of the outside surfaces 120a of the two weights 120, which increases the weight of the mass body 12 without increasing the radial length or the thickness of the mass body 12 (weights 120). Thus, the vibration damping effect can be improved while suppressing an increase in size of the device. The recessed portion 121 is formed at both end portions, in the circumferential direction, of the two weights 120. Thus, a rotation moment of the mass body 12 about the center of gravity can be further increased to further improve the vibration damping effect.

In the embodiment, further, the cushioning member 150 is attached to the attachment portion 124 which is formed by bringing the respective projecting portions 122 of the two weights 120 into abutment with each other. Thus, a shock applied when the cushioning member 150 and the support member 11 abut against each other or when the respective cushioning members 150 of the mass bodies 12 which are adjacent to each other in the circumferential direction abut against each other along with swing of the mass bodies 12 can be reduced to improve the durability of the device.

In the centrifugal-pendulum vibration absorbing device 10 according to the embodiment described above, each of the two weights 120 is provided with the recessed portion 121 which is recessed from the outside surface 120a toward the inside surface 120b, and the additional weight 130 which is formed of a material that is higher in specific gravity than the weight 120 is attached to the recessed portion 121. Consequently, the weight of the mass body 12 can be increased without increasing the radial length or the thickness of the mass body 12 (weights 120). As a result, the vibration damping effect can be improved while suppressing an increase in size of the device. The recessed portion 121 is formed at both end portions, in the circumferential direction, of the two weights 120. Consequently, a rotation moment of the mass body 12 about the center of gravity can be further increased to further improve the vibration damping effect.

In the centrifugal-pendulum vibration absorbing device 10 according to the embodiment, in addition, the cushioning member 150 is attached to the attachment portion 124 which is constituted by bringing the respective projecting portions 122 of the two weights 120 into abutment with each other. Consequently, a shock applied when the cushioning member 150 and the support member 11 abut against each other or when the respective cushioning members 150 of the mass bodies 12 which are adjacent to each other in the circumferential direction abut against each other along with swing of the mass bodies 12 can be reduced. As a result, the durability of the device can be improved.

In the centrifugal-pendulum vibration absorbing device 10 according to the embodiment, as illustrated in FIG. 5, the head portion 141 and the distal end portion (swaging portion) 142 of the rivet 140 project from the respective outside surfaces 130a of the additional weights 130. As illustrated in relation to a mass body 12B of a centrifugal-pendulum vibration absorbing device 10B according to the modification in FIG. 6, however, a recessed portion (spot facing) 132B that is larger in outside diameter than the through hole 131 may be formed on the side of the outside surfaces 130a of additional weights 130B around the through hole 131, and a head portion 141B and a distal end portion (swaging portion) 142B of a rivet 140B may be accommodated in the recessed portion 132B. This allows a reduction in length, in the axial direction (left-right direction of FIG. 6), of the mass body 12 and hence the device.

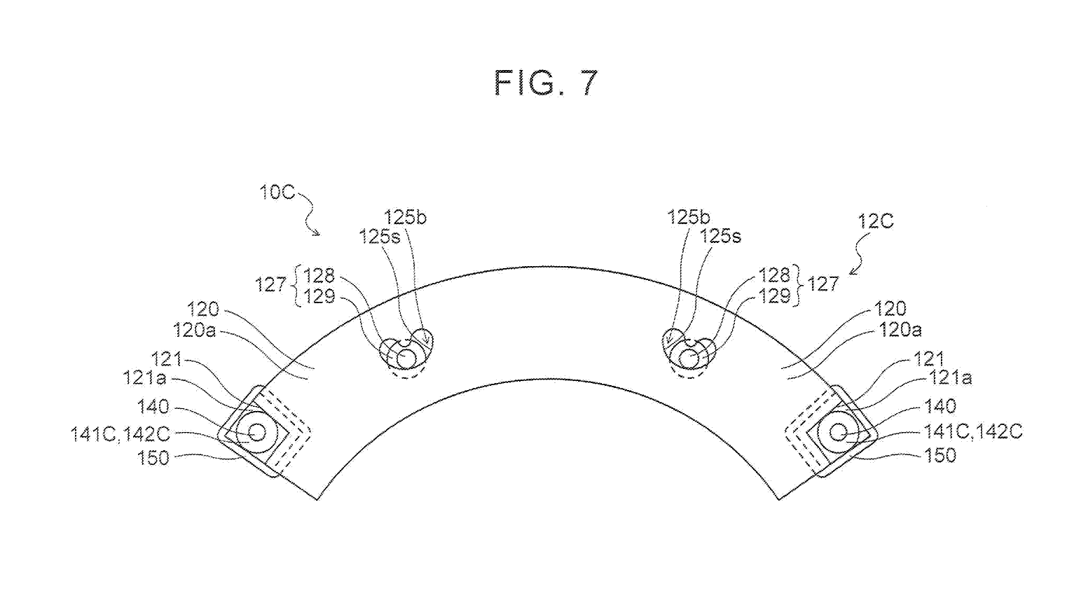

In the centrifugal-pendulum vibration absorbing device 10 according to the embodiment, as illustrated in FIGS. 2 and 5, the mass body 12 is constituted by coupling the weights 120 to each other using the rivet 140 with the additional weights 130 disposed in the respective recessed portions 121 which are formed on the side of the outside surfaces 120a of the weights 120. As illustrated in relation to a mass body 12C of a centrifugal-pendulum vibration absorbing device 10C according to the modification in FIG. 7, however, a rivet 140C formed of a material that is higher in specific gravity than the weight 120 may be inserted through the through holes 123 of the respective projecting portions 122 of the two weights 120 and a distal end portion 142C of the rivet 140C may be swaged so that the two weights 120 are coupled to each other and a head portion 141C and the distal end portion 142C of the rivet 140C are accommodated (disposed) in the respective recessed portions 121 of the weights 120. This allows the rivet 140C, which couples the two weights 120 to each other, to function also as the additional weight. It should be noted, however, that the head portion 141C and the distal end portion 142C of the rivet 140C are preferably formed to be as large as possible within such a range that the head portion 141C and the distal end portion 142C are accommodated in the respective recessed portions 121 of the weights 120.

In the centrifugal-pendulum vibration absorbing device 10 according to the embodiment, the additional weight 130 is attached to each of the recessed portions 121 which are formed at the outer peripheral portion (a portion on the outer peripheral side with respect to generally the center in the radial direction) on the side of the outside surfaces 120a of the weights 120. However, an additional weight may be attached to each of recessed portions formed slightly on the inner side, in the radial direction, with respect to the outer peripheral portion. In addition, if the outside diameter of the small-diameter portion 110 of the support member 11 is smaller than the inside diameter of the mass body 12 (weights 120), an additional weight may be attached to each of recessed portions formed over the entirety, in the radial direction, on the side of the outside surfaces 120a of the weights 120.

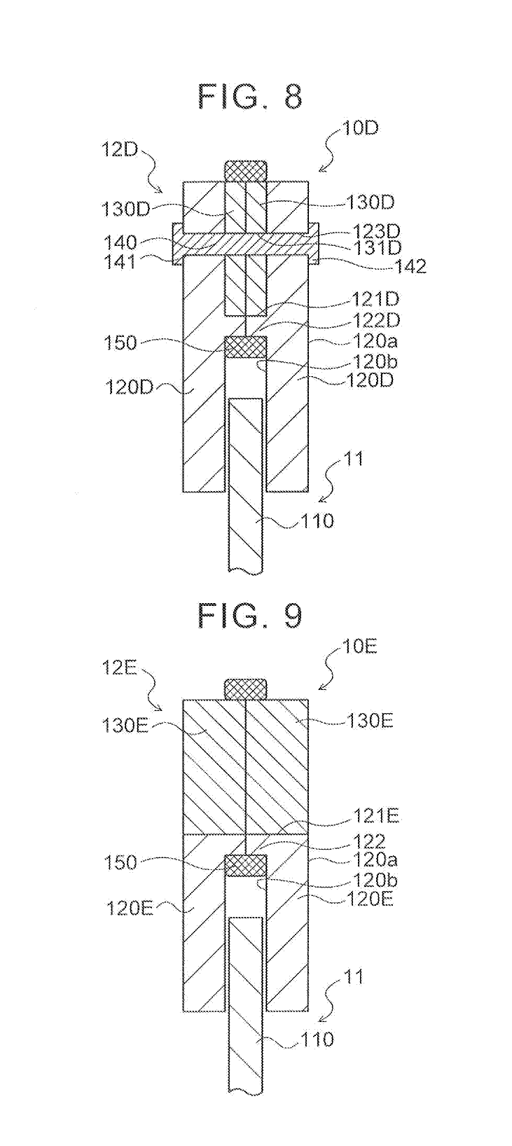

In the centrifugal-pendulum vibration absorbing device 10 according to the embodiment, each of the weights 120 is provided with the recessed portion 121 which is recessed from the outside surface 120a toward the inside surface 120b, and the additional weight 130 is attached to the recessed portion 121. As illustrated in relation to a mass body 12D of a centrifugal-pendulum vibration absorbing device 10D according to the modification in FIG. 8, however, a recessed portion 121D recessed from the inside surface 120b toward the outside surface 120a may be formed in a projecting portion 122D of each of weights 120D that projects toward the opposing weight 120D or the like, and an additional weight 130D may be attached to the recessed portion 121D. In this case, through holes 123D and 131D are formed in the weights 120D and the additional weights 130D, respectively, and the two weights 120D and the two additional weights 130D may be coupled to each other by the rivet 140 which is inserted through the through holes 123D and 131D of the weights 120D and the additional weights 130D, respectively. In addition, each of the weights may be provided with a recessed portion that is recessed from an end surface of the outer peripheral surface toward the inner peripheral surface, and an additional weight may be attached to the recessed portion. Further, each of the weights may be provided with a recessed portion that is recessed from an end surface in the circumferential direction toward the inner side in the circumferential direction, and an additional weight may be attached to the recessed portion. As illustrated in relation to a mass body 12E of a centrifugal-pendulum vibration absorbing device 10E according to the modification in FIG. 9, additionally, each of weights 120E may be provided with a recessed portion 121E that is recessed from an end surface of the outer peripheral surface and an end surface in the circumferential direction toward the inner peripheral surface and the inner side in the circumferential direction, and an additional weight 130E may be attached to the recessed portion 121E. In the case where the weight 120E and the additional weight 130E are not arranged side by side in the axial direction as in the case of FIG. 9, the additional weight 130E is preferably attached to the weight 120E by welding or the like. In this case, in addition, the two weights 120E may be coupled to each other by a rivet inserted through a through hole formed in the weights 120E, or the small-diameter roller 128 of the guide roller 127 may also be used as a rivet, that is, the small-diameter roller 128 may have a function of rolling along the inner peripheral surface 125s of the guide opening portion 125a or 125b and a function of coupling the two weights 120 to each other.

In the centrifugal-pendulum vibration absorbing device 10 according to the embodiment, the additional weight 130 is attached to each of the recessed portions 121 which are formed at the outer peripheral portion of both end portions, in the circumferential direction, on the side of the outside surfaces 120a of the weights 120. However, an additional weight may be attached to each of the recessed portions formed at other positions (such as at the outer peripheral portion at generally the center in the circumferential direction, for example) in addition to or in place of both end portions in the circumferential direction.

In the centrifugal-pendulum vibration absorbing device 10 according to the embodiment, the recessed portions 121 and the projecting portions 122 of each of the weights 120 are formed by pressing a flat metal plate. However, the recessed portions 121 and the projecting portions 122 may be formed by otherwise processing (e.g. cutting) a flat metal plate (plate body) than pressing.

In the centrifugal-pendulum vibration absorbing device 10 according to the embodiment, the mass body 12 is constituted by coupling the two weights 120 to each other together with the additional weights 130 using the rivet 140. However, the mass body 12 may be constituted by attaching the additional weight 130 to each of the weights 120 by welding or the like and coupling the two weights 120 to each other using a rivet or the like.

In the centrifugal-pendulum vibration absorbing device 10 according to the embodiment, each of the weights 120 is provided with the recessed portions 121 and the projecting portions 122. However, each of the weights 120 may be provided with only the recessed portions 121, and not provided with the projecting portions 122 (with the inside surface of the weight formed as a flat surface). In this case, as in the case where the projecting portions 122 are formed, a through hole is formed in the respective bottom surfaces of the recessed portions 121 of the weights 120 and the additional weights 130, and the two weights 120 and the two additional weights 130 may be coupled to each other by a rivet inserted through the through hole in the recessed portions 121 of the weights 120 and the additional weights 130. In this case, a recessed portion (spot facing) that is larger in outside diameter than the through hole may be formed on the side of the outside surfaces of the additional weights 130 around the through hole, and a head portion and a distal end portion (swaging portion) of the rivet may be accommodated in the recessed portion. This allows a reduction in length, in the axial direction (left-right direction of FIG. 6), of the mass body 12 and hence the device. In addition, a cushioning member formed of an elastic body such as a rubber material or the like may be disposed between the two weights. Further, the two weights may be disposed so as to face each other via the support member, and the small-diameter roller 128 of the guide roller 127 may also be used as a rivet, that is, the small-diameter roller 128 may have a function of rolling along the inner peripheral surface 125s of the guide opening portion 125a or 125b and a function of coupling the two weights 120 to each other. In this case, the additional weight 130 may be attached to the weight 120 by means other than riveting (such as welding, for example). Also in this case, the support member 11 may not include the small-diameter portion 110 (may be formed in an annular shape that is generally equal in outside diameter to the large-diameter portion 112).

In the centrifugal-pendulum vibration absorbing device 10 according to the embodiment, the cushioning member 150 is attached to the attachment portion 124 which is formed by bringing the respective projecting portions 122 of the two weights 120 into abutment with each other. However, no such cushioning member may be attached.

In the centrifugal-pendulum vibration absorbing device 10 according to the embodiment, each of the mass bodies 12 is supported by the support member 11 so as to be turnable about the pendulum fulcrum and rotatable about the center of gravity. However, each of the mass bodies 12 may be supported by the support member 11 so as to be turnable about the pendulum fulcrum but not to be rotatable about the center of gravity.

The correspondence between the main elements of the embodiment and the main elements of the disclosure described in the “SUMMARY” section will be described. In the embodiment, the support member 11 corresponds to the “support member”. The plurality of mass bodies 12 correspond to the “plurality of mass bodies”. The additional weight 130 corresponds to the “additional weight”.

The correspondence between the main elements of the embodiment and the main elements of the disclosure described in the “SUMMARY” section does not limit the elements of the disclosure described in the “SUMMARY” section, because such correspondence is an example given for the purpose of specifically describing the disclosure described in the “SUMMARY” section. That is, the disclosure described in the “SUMMARY” section should be construed on the basis of the description in that section, and the embodiment is merely a specific example of the disclosure described in the “SUMMARY” section.

While a mode for carrying out the present subject matter has been described above by way of an embodiment, it is a matter of course that the present disclosure is not limited to the embodiment in any way, and that the present subject matter may be implemented in various forms.

### INDUSTRIAL APPLICABILITY

The present subject matter is applicable to the centrifugal-pendulum vibration absorbing device manufacturing industry and so forth.

1-11. (canceled)

12. A centrifugal-pendulum vibration absorbing device comprising:
a support member attached to a rotary element; and
a plurality of mass bodies each swingably supported by the support member and disposed adjacent to each other in a circumferential direction, wherein:
the mass bodies each includes two weights coupled to face each other via the support member;
each of the weights is provided with a recessed portion that is recessed from a surface of each of the weights toward an inner side of each of the weights; and
an additional weight formed of a material that is higher in specific gravity than each of the weights is attached to the recessed portion.

13. The centrifugal-pendulum vibration absorbing device according to claim 12, wherein
the recessed portion is formed at both end portions, in the circumferential direction, of each of the weights.

14. The centrifugal-pendulum vibration absorbing device according to claim 13, wherein:
the recessed portion is a recessed portion that is recessed from one of an outside surface and an inside surface, in an axial direction, of each of the weights toward the other;
a through hole is formed in a bottom surface of the recessed portion of each of the weights and the additional weight; and
the two weights are coupled to each other by a rivet inserted through the through hole in the recessed portion of each of the weights and the additional weight.

15. The centrifugal-pendulum vibration absorbing device according to claim 14, wherein
the additional weight is formed with a rivet recessed portion that accommodates both end portions of the rivet.

16. The centrifugal-pendulum vibration absorbing device according to claim 15, wherein
the recessed portion is a recessed portion that is recessed from an outside surface toward an inside surface of each of the weights in an axial direction.

17. The centrifugal-pendulum vibration absorbing device according to claim 16, wherein:
each of the weights is provided with a projecting portion that forms a bottom surface of the recessed portion and that projects in a coupling direction of each of the two weights; and
a cushioning member is attached to an attachment portion constituted from the projecting portion of each of the two weights.

18. The centrifugal-pendulum vibration absorbing device according to claim 17, wherein
the recessed portion and the projecting portion are formed by pressing a plate body.

19. The centrifugal-pendulum vibration absorbing device according to claim 18, wherein:
a through hole is formed in the projecting portion and the additional weight; and
the two weights are coupled to each other by a rivet inserted through the through hole in the projecting portion and the additional weight.

20. The centrifugal-pendulum vibration absorbing device according to claim 19, wherein
the additional weight is provided with a rivet recessed portion that accommodates both end portions of the rivet.

21. The centrifugal-pendulum vibration absorbing device according to claim 20, wherein
each of the mass bodies is supported by the support member so as to be swingable about a pendulum fulcrum and rotatable about a center of gravity.

22. The centrifugal-pendulum vibration absorbing device according to claim 12, wherein:
the recessed portion is a recessed portion that is recessed from one of an outside surface and an inside surface, in an axial direction, of each of the weights toward the other;
a through hole is formed in a bottom surface of the recessed portion of each of the weights and the additional weight; and
the two weights are coupled to each other by a rivet inserted through the through hole in the recessed portion of each of the weights and the additional weight.

23. The centrifugal-pendulum vibration absorbing device according to claim 22, wherein
the additional weight is formed with a rivet recessed portion that accommodates both end portions of the rivet.

24. The centrifugal-pendulum vibration absorbing device according to claim 12, wherein
the recessed portion is a recessed portion that is recessed from an outside surface toward an inside surface of each of the weights in an axial direction.

25. The centrifugal-pendulum vibration absorbing device according to claim 12, wherein:
each of the weights is provided with a projecting portion that forms a bottom surface of the recessed portion and that projects in a coupling direction of each of the two weights; and
a cushioning member is attached to an attachment portion constituted from the projecting portion of each of the two weights.

26. The centrifugal-pendulum vibration absorbing device according to claim 25, wherein
the recessed portion and the projecting portion are formed by pressing a plate body.

27. The centrifugal-pendulum vibration absorbing device according to claim 25, wherein:
a through hole is formed in the projecting portion and the additional weight; and
the two weights are coupled to each other by a rivet inserted through the through hole in the projecting portion and the additional weight.

28. The centrifugal-pendulum vibration absorbing device according to claim 27, wherein
the additional weight is provided with a rivet recessed portion that accommodates both end portions of the rivet.

29. The centrifugal-pendulum vibration absorbing device according to claim 24, wherein
the two weights are coupled to each other by a rivet formed of a material that is higher in specific gravity than each of the weights; and
both end portions of the rivet are disposed in the recessed portion to function as the additional weight.

30. The centrifugal-pendulum vibration absorbing device according to claim 12, wherein
each of the mass bodies is supported by the support member so as to be swingable about a pendulum fulcrum and rotatable about a center of gravity.

31. The centrifugal-pendulum vibration absorbing device according to claim 13, wherein
the recessed portion is a recessed portion that is recessed from an outside surface toward an inside surface of each of the weights in an axial direction.
